(19) United States
(12) Patent Application Publication
(10) Pub. No.: US 2011/0140758 A1
(43) Pub. Date: Jun. 16, 2011

(54) ANALOG MULTIPLIER

(75) Inventor: Fu-Yang Shih, Hsinchu City (TW)

(73) Assignee: MACROBLOCK, INC., Hsinchu City (TW)

(21) Appl. No.: 12/967,154

(22) Filed: Dec. 14, 2010

(30) Foreign Application Priority Data
Dec. 16, 2009 (TW) 098223618

(51) Int. Cl. G06G 7/16

(52) U.S. Cl. 327/356

(57) ABSTRACT

An analog multiplier includes a bias circuit, a level shifter, a multiplying circuit, and a current mirror. The analog multiplying circuit is used for inputting a first voltage and a second voltage, and outputting a product current. The product current is proportional to a product of the first voltage and the second voltage. The analog multiplier is implemented by a few devices, thereby having a simple architecture and being capable of being driven by a small amount of power.

### CROSS-REFERENCE TO RELATED APPLICATIONS

This non-provisional application claims priority under 35 U.S.C. §119(a) on Patent Application No(s). 098223618 filed in Taiwan, R.O.C. on Dec. 16, 2009, the entire contents of which are hereby incorporated by reference.

### BACKGROUND OF THE INVENTION

1. Field of the Invention

The present invention relates to an analog multiplier, and more particularly to an analog multiplier having a simple architecture.

2. Related Art

As the semiconductor technology continuously develops, products developed through the semiconductor technology appear everywhere. Semiconductor circuits may be categorized into digital circuits and analog circuits according to different signals being processed.

Digital and the analog circuits are widely used in computing devices, communication devices, or control systems. Among these applications, the multiplier is a frequently used element. Generally, multipliers can also be divided into digital multipliers and analog multipliers.

An advantage of the digital multiplier is that accurate values can be obtained with less susceptibility to device characteristics. In addition, the digital multiplier can be designed with simple logic circuits. However, the digital multiplier needs to convert output signals or input signals via an analog-to-digital converter or a digital-to-analog converter. Therefore, on the whole, the architecture of the digital multiplier is more complicated.

An advantage of the analog multiplier is its simple architecture. However, the accuracy of the analog multiplier is vulnerable to parametric variations of semiconductor devices. With more devices being used in a single analog multiplier, characteristic deviations among devices become worse. That is to say, the yield of the analog multiplier becomes lower accordingly. Moreover, the power consumption also increases with the complexity of devices.

### SUMMARY OF THE INVENTION

In view of the above problems, the present invention provides an analog multiplier with a simple architecture.

The analog multiplier comprises a bias circuit, a level shifter, a multiplying circuit, and a current mirror. The analog multiplying circuit is used for inputting a first voltage and a second voltage, and outputting a product current proportional to a product of the first voltage and the second voltage.

The bias circuit is used for inputting the first voltage. The level shifter is used for inputting the second voltage, and shifting the second voltage to a third voltage. The multiplying circuit is connected to the bias circuit and the level shifter and used for inputting the first voltage and the third voltage to generate the output product current.

The product current is thereby output by the current mirror. The current mirror possesses a master side and a slave side. The master side receives the output product current of the multiplying circuit, and the slave side generates a mirror current equal to the output product current of the multiplying circuit.

The analog multiplier based on the present invention has a simple architecture. The analog multiplier requires fewer devices, making it possible to enhance the process yield and reduce the manufacturing costs. In addition, the analog multiplier with a simple architecture can be driven by a small amount of power, and thus is applicable to applications of which supplied power is limited.

### BRIEF DESCRIPTION OF THE DRAWINGS

The present invention will become more fully understood from the detailed description given herein below for illustration only, and thus are not limitative of the present invention, and wherein:

FIG. 1 is a system block diagram of the present invention;

FIG. 2 is a circuit diagram according to an embodiment of the present invention; and

FIG. 3 is a circuit diagram of the present invention using a cascade current mirror in combination.

### DETAILED DESCRIPTION OF THE INVENTION

The detailed features and advantages of the present invention will be described in detail in the following embodiments. The embodiments below are intended to further describe the ideas of the present invention instead of limiting the scope thereof.

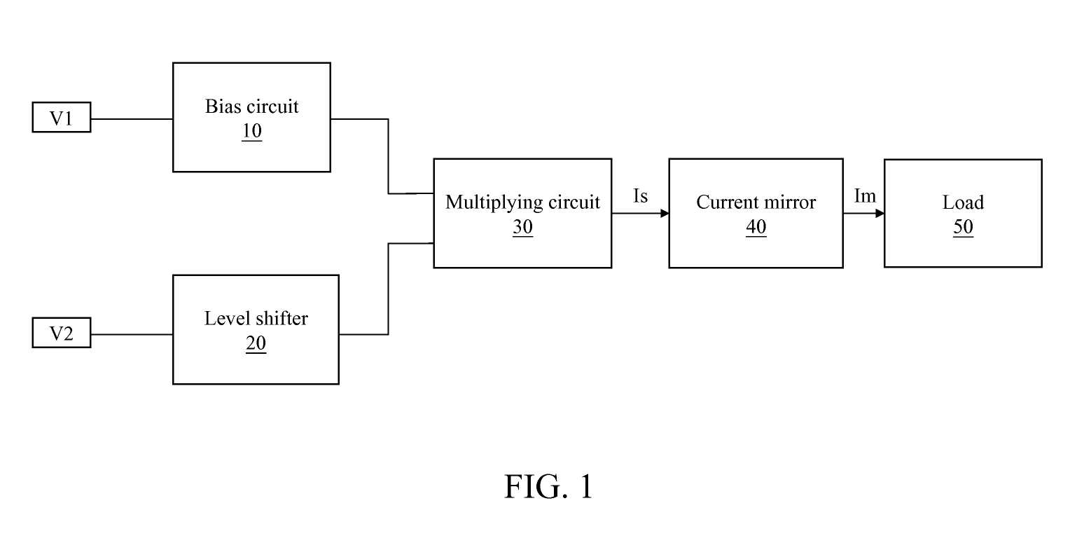

FIG. 1 is a system block diagram of the present invention. An analog current mirror comprises a bias circuit 10, a level shifter 20, a multiplying circuit 30, and a current mirror 40. The bias circuit 10 and the level shifter 20 are connected to the multiplying circuit 30. The multiplying circuit 30 is connected to the current mirror 40. The current mirror 40 mirrors the current output by the multiplying circuit 30 and outputs a current thereof.

The bias circuit 10 is used for inputting a first voltage V1, and forces an output at the first voltage V1. The bias circuit 10 is also technically referred to as an unit gain buffer amplifier or an isolation amplifier.

The level shifter 20 is used for inputting a second voltage V2, and shifts the second voltage V2 to a third voltage V3. The third voltage V3 is approximately equal to the second voltage V2 plus a threshold voltage Vthp (a P-channel Metal Oxide Semiconductor (PMOS) threshold voltage).

The multiplying circuit 30 is used for inputting the first voltage V1 and the third voltage V3, and generating a product current Is. The product current is proportional to a product of the first voltage V1 and the third voltage V3 minus a threshold voltage Vthn (an N-channel Metal Oxide Semiconductor (NMOS) threshold voltage).

The current mirror 40 has a master side and a slave side. The master side receives the output product current Is of the multiplying circuit 30, and the slave side generates a mirror current Im equal to the product current Is. The slave side eventually delivers the mirror current to a load 50.

Based on the architecture, an analog multiplier having a simple architecture is designed. In order to make the implementation of the present invention more explicit, an embodiment of the present invention is illustrated in detail as follows.

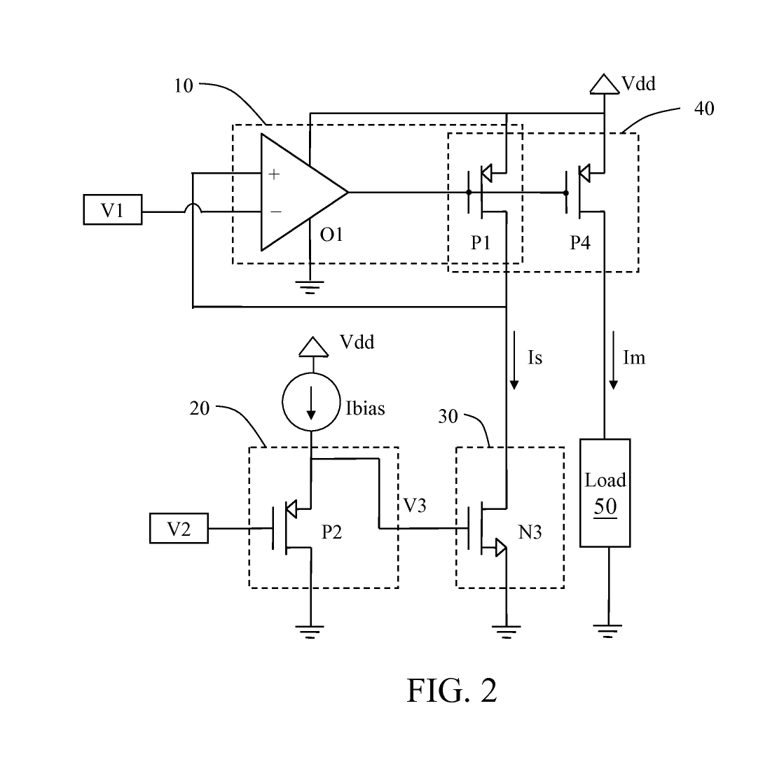

FIG. 2 is a circuit diagram according to an embodiment of the present invention. The circuit comprises an operational amplifier O1, a first transistor P1, a second transistor P2, a third transistor N3, and a fourth transistor P4. The circuit further comprises a voltage source Vdd and a current source Ibias. The first transistor P1, the second transistor P2, the third transistor N3, and the fourth transistor P4 can be, but not limited to, Metal Oxide Semiconductors (MOSs).

A bias circuit 10 comprises an operational amplifier O1 and a first transistor P1. The operational amplifier O1 has two input terminals (a non-inverting input terminal and a inverting input terminal) and one output terminal. A first voltage V1 is input to the inverting input terminal of the operational amplifier O1. The output terminal is connected to a gate of the first transistor P1. A drain of the first transistor P1 is connected to the non-inverting input terminal of the operational amplifier O1, and a source of the first transistor P1 is connected to a voltage source Vdd. Here, the operational amplifier O1 along with the first transistor P1 forms a negative feedback closed-loop system. Therefore, a voltage of the non-inverting input terminal of the operational amplifier O1 and a voltage of the inverting input terminal of the operational amplifier O1 would be forced equal, which is technically referred to as virtual short. More explicitly, a drain voltage of the first transistor P1 is equal to the first voltage V1.

A level shifter 20 comprises a second transistor P2. A second voltage V2 is input to a gate of the second transistor P2. A source of the second transistor P2 is connected to a bias current source Ibias, and a drain of a second transistor P2 of connected to a common ground supply The bias current source Ibias is extremely small, such that a source voltage of the second transistor P2 is approximately equal to the second voltage V2 plus a threshold voltage Vthpto generate a third voltage V3. More explicitly, V3 can be expressed as V3=V2+Vthp.

A multiplying circuit 30 comprises a third transistor N3. A gate of the third transistor N3 is connected to the source of the second transistor P2, a drain of the third transistor N3 is connected to the drain of the first transistor P1, and a source of N3 is connected to a common ground supply.

When a gate/source voltage difference (Vgs) of the third transistor N3 minus a threshold voltage Vthn is greater than a drain/source voltage difference (Vds) (Vgs-Vthn>Vds), the third transistor N3 is operated in a linear or a triode region. Under such a premise, a product current Is flowing through the third transistor N3 is proportional to a product of the gate/source voltage difference (Vgs) minus the threshold voltage Vthn and the drain/source voltage difference (Vds), which may be expressed as Is=C×(Vgs−Vthn)×Vds, in which C is a positive constant.

A gate voltage of the third transistor N3 is the third voltage V3, a drain voltage of the third transistor N3 is the first voltage V1, and a source voltage of the third transistor N3 is grounded, that is, a zero voltage. Therefore, the gate/source voltage difference (Vgs) is the third voltage V3, and the drain/source voltage difference (Vds) is the first voltage V1. The first voltage V1 and the third voltage V3 are substituted into the expression, so as to obtain Is=C×(V3−Vthn)×V1. Next, V3=V2+Vthp is substituted into the expression, so as to obtain Is=C×(V2+Vthp−Vthn)×V1, in which if Vthp approximates to Vthn, Is≈C×V2×V1.

It is explicitly known that the product current Is of the third transistor N3 is proportional to a product of the first voltage V1 and the second voltage V2.

In order to alleviate an effect of an output load on the product current Is, the load and the product current Is may be connected via a current mirror 40. The current mirror 40 comprises a first transistor P1 and a fourth transistor P4. Preferably, the first transistor P1 and the fourth transistor P4 have the same process parameters (length/width). The first transistor P1 is a master side of the current mirror 40, and the fourth transistor P4 is a slave side of the current mirror 40.

The gate of the first transistor P1 is connected to a gate of the fourth transistor P4. The source of the first transistor P1 and a source of the fourth transistor P4 are connected to the voltage source Vdd. Therefore, a gate voltage of the first transistor P1 is identical to a gate voltage of the fourth transistor P4, and a source voltage of the first transistor P1 is identical to a source voltage of the fourth transistor P4. When the first transistor P1 and the fourth transistor P4 are operated in a saturation region, and the first transistor P1 and the fourth transistor P4 have the same process parameters, drain currents of the first transistor P1 and the fourth transistor P4 are also identical. That is to say, a mirror current of the slave side is equal to an input current of the master side.

The input current of the master side is the product current Is of the third transistor N3, such that the mirror current of the slave side is herein equal to the product current Is of the third transistor N3. Next, the slave side eventually delivers the mirror current (that is, the product current Is) to the load 50.

Through the current mirror 40, the product current Is of the third transistor N3 may be successfully delivered to the load 50, and meanwhile the load 50 is isolated from the third transistor N3, thereby alleviating the effect of loading variations on the third transistor N3.

Although in this embodiment, the architecture of the current mirror 40 is formed by the first transistor P1 and the fourth transistor P4, the architecture of the current mirror 40 as shown in FIG. 2 is not used to limit the scope of the present invention.

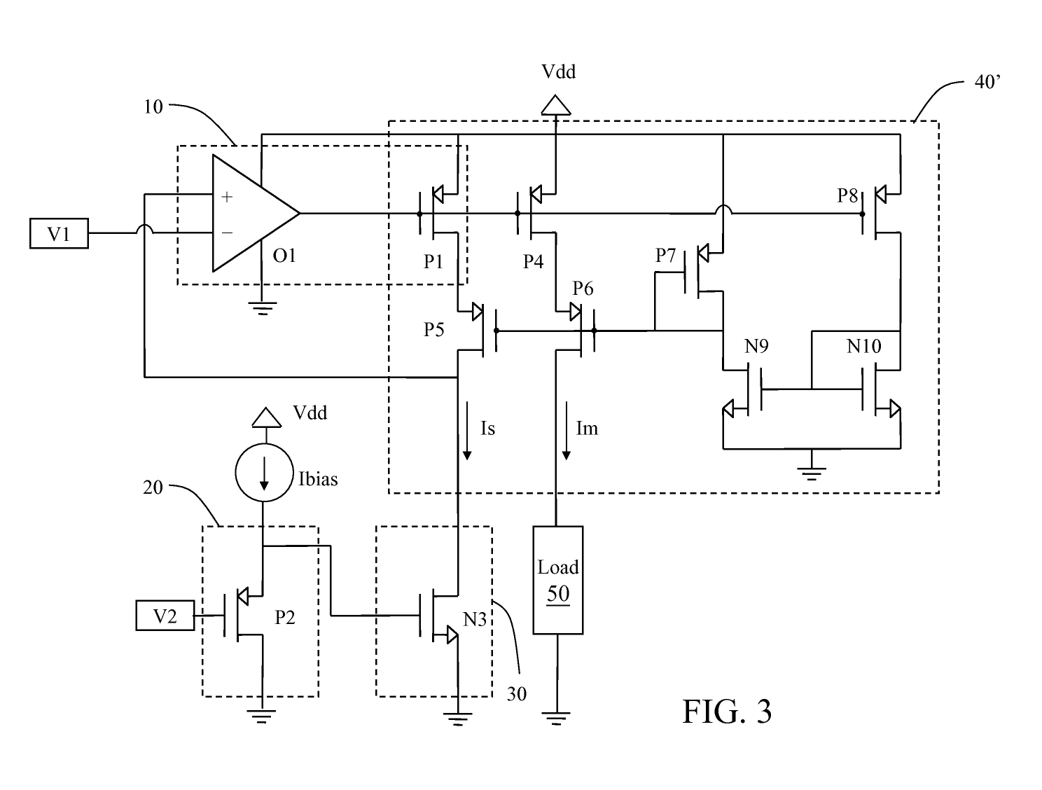

For example, the current mirror 40 as shown in FIG. 2 may be replaced by a cascade current mirror 40′. FIG. 3 is a circuit diagram of the present invention using the cascade current mirror 40′ in combination.

The cascade current mirror 40′ may further increase an output impendence, that is, further reduce a current difference resulting from unbalanced load of two terminals of the current mirror, thereby improving an accuracy of the current mirror.

In addition to a first transistor P1 and a fourth transistor P4, the cascade current mirror 40′ further comprises a fifth transistor P5, a sixth transistor P6, a seventh transistor P7, an eighth transistor P8, a ninth transistor N9, and a tenth transistor N10.

The first transistor P1 and the fifth transistor P5 are connected in series, and the fourth transistor P4 and the sixth transistor P6 are connected in series. The first transistor P1 and the fifth transistor P5 are the master side, and the fourth transistor P4 and the sixth transistor P6 are the slave side.

A gate of the first transistor P1 is connected to a gate of the fourth transistor P4, and a source of the first transistor P1 and a source of the fourth transistor P4 are connected to a voltage source Vdd. A gate of the fifth transistor P5 is connected to a gate of the sixth transistor P6. The seventh transistor P7, the eighth transistor P8, the ninth transistor N9, and the tenth transistor N10 are used to supply a gate bias of the fifth transistor P5 and the sixth transistor P6, such that the first transistor P1, the fourth transistor P4, the fifth transistor P5, and the sixth transistor P6 are operated in a saturation region.

When the first transistor P1 and the fourth transistor P4 have the same process parameters, and the fifth transistor P5 and the sixth transistor P6 also have the same process parameters, a current flowing through the first transistor P1 and the fifth transistor P5 is equal to a current flowing through the fourth transistor P4 and the sixth transistor P6.

The above contents are only different implementations of two current mirrors. It is possible to achieve the efficacies of the present invention by using other current mirrors, for example, a Wilson current mirror or a Wilder current mirror.

The analog multiplier based on the present invention has a simple architecture. As shown in FIG. 2, the analog multiplier may be implemented by a few devices. The analog multiplier requires fewer devices, such that a yield of the analog multiplier may be enhanced, and reduce the manufacturing costs. In addition, the analog multiplier with a simple architecture can be driven by a small amount of power, thus applicable to applications of which supplied power is limited.

What is claimed is:

1. An analog multiplier, for inputting a first voltage and a second voltage, and outputting a product current, the analog multiplier comprising:
a bias circuit, for inputting the first voltage;
a level shifter, for inputting the second voltage, and shifting the second voltage to a third voltage;
a multiplying circuit, connected to the bias circuit and the level shifter, for inputting the first voltage and the third voltage to generate the product current; and
a current mirror, possessing a master side and a slave side, wherein the master side receives the product current of the multiplying circuit, and the slave side generates a mirror current equal to the output product current of the multiplying circuit;
wherein the product current is proportional to a product of the first voltage and the second voltage.

2. The analog multiplier according to claim 1, wherein the multiplying circuit comprises a third transistor, a gate of the third transistor is connected to the level shifter, and a drain of the third transistor is connected to the bias circuit.

3. The analog multiplier according to claim 2, wherein the bias circuit comprises an operational amplifier and a first transistor, the first voltage is input to a reverse input end of the operational amplifier, an output end of the operational amplifier is connected to a gate of the first transistor, a drain of the first transistor gives a feedback to a non-reverse input end of the operational amplifier and the drain of the third transistor, and a voltage of the drain of the third transistor is equal to the first voltage.

4. The analog multiplier according to claim 1, wherein the level shifter comprises a second transistor, the second voltage is a gate voltage of the second transistor, the third voltage is a source voltage of the second transistor, and the third voltage is equal to the second voltage plus a threshold voltage.

5. The analog multiplier according to claim 1, wherein the current mirror is a cascade current mirror.
